(19) United States
(12) Patent Application Publication
(10) Pub. No.: US 2008/0021623 A1
(43) Pub. Date: Jan. 24, 2008

(54) Redundant Brake Control System for a Vehicle

(75) Inventors: Gerhard Frey, Esslingen (DE); Ottmar Gehring, Kernen (DE); Harro Heilmann, Ostfildern (DE); Andreas Schwarzhaupt, Landau (DE); Gernot Spiegelberg, Heimsheim (DE); Armin Sulzmann, Heidelberg (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/590,696

(22) PCT Filed: Feb. 23, 2005
(86) PCT No.: PCT/EP05/01871

§ 371 Date: May 25, 2007

(30) Foreign Application Priority Data
Feb. 27, 2004 (DE) 10 2004 009 469.1

(51) Int. Cl. B60T 8/88

(52) U.S. Cl. 701/70

(57) ABSTRACT

A brake control system for a vehicle, in particular a commercial vehicle, includes a service brake for braking the wheels of the vehicle. To increase operating safety, the service brake is equipped with an electronically actuatable brake unit for each wheel for actuating the brake of the respective wheel. Two redundantly connected central control devices are connected via control lines to the brake units so as to actuate the brake units independently of one another.

### BACKGROUND AND SUMMARY OF THE INVENTION

This application is a National Phase of PCT/EP2005/001871, filed Feb. 23, 2005, and claims the priority of German patent document 10 2004 009 469.1, filed Feb. 27, 2004, the disclosure of which is expressly incorporated by reference herein.

The present invention relates to a brake control system for a vehicle, in particular a commercial vehicle, wherein the vehicle comprises at least one front axle with at least one left-hand front wheel and at least one right-hand front wheel, and at least one rear axle with at least one left-hand rear wheel and at least one right-hand rear wheel, wherein the brake control system comprises a service brake for braking the wheels of the vehicle.

DE 100 32 179 A1 discloses a vehicle with a control system which operates with an electronically actuatable drive train, which comprises at least one steering system and one drive unit of the vehicle. The known control system has an input level with devices for inputting values continuously preset by a driver and converting these preset values into setpoint signals. The control system further comprises a coordination level for converting the setpoint signals into triggering signals that are converted by actuators of the drive train. That is, the control system has a control device which, from a motion vector on the input side, generates control signals on the output side for actuating the drive train and which is coupled to the drive train for transmission of the control signals. The drive train then executes the control signals in order to implement the driver's wishes, i.e., it is a so-called “drive-by-wire system” or “X-by-wire system”.

DE 100 46 832 A1 discloses another control system which is suitable for controlling a vehicle equipped with an electronically actuatable drive train. A memory device stores vehicle data relevant to vehicle movement dynamics, time data, position data, actuation signals from the driver and triggering signals for the drive train generated by a control device. Such a control system allows improved accident analysis.

In today's vehicles, the service brake comprises hydraulic brake actuators, which are associated with the individual vehicle wheels. To increase vehicle safety, a two-circuit system is generally provided and has two independent hydraulic circuits one of the circuits serves to actuate the brake actuators associated with the rear axle while the other actuates the brake actuators associated with the front axle. With this construction, the brake actuators associated with the same axle are coupled together via the common hydraulic circuit. This coupling means that, if one of the hydraulic circuits fails, all the brake actuators linked into this hydraulic circuit always fail.

EP 0 832 800 A2 discloses an electronic braking system with various hierarchical levels for the architecture of the brake control system. In addition to vehicle modules, wheel modules are provided which exchange messages with a central module within one hierarchical level via a data bus. EP 1 231 121 A2 also describes the structural configuration of a data bus system for brake actuation.

An object of the present invention is to solve the problem of providing an improved embodiment for a vehicle of the abovementioned type, which offers in particular increased safety.

The invention is based on the general concept of providing the service brake with electronically actuatable brake units associated with the individual wheels. The brake units may be actuated independently of one another by two central, redundantly connected service brake control devices. In this way, a four-circuit system may be produced, for example, without a particularly high degree of complexity being required. In particular, no hydraulic lines have to be installed, since the control lines used to actuate the brake units merely have to be suitable for transmitting electrical control signals and thus are considerably cheaper than hydraulic lines. The electrical control lines are not only cheaper to purchase than hydraulic lines but also require less effort to install.

The second central control device provides a redundant brake control system so that the fail safety of the brake system is considerably improved. The two control devices are connected to the individual brake units such that both control devices operate permanently in parallel and may replace one another immediately and completely in the event of failure. At the same time, the line arrangement according to the invention reduces the amount of line material used and the labor required for installation.

Other objects, advantages and novel features of the present invention will become apparent from the following detailed description of the invention when considered in conjunction with the accompanying drawings.

### BRIEF DESCRIPTION OF THE DRAWINGS

FIGS. 1 to 7 are schematic views of seven embodiments of a vehicle with a brake control system according to the present invention.

### DETAILED DESCRIPTION OF THE DRAWINGS

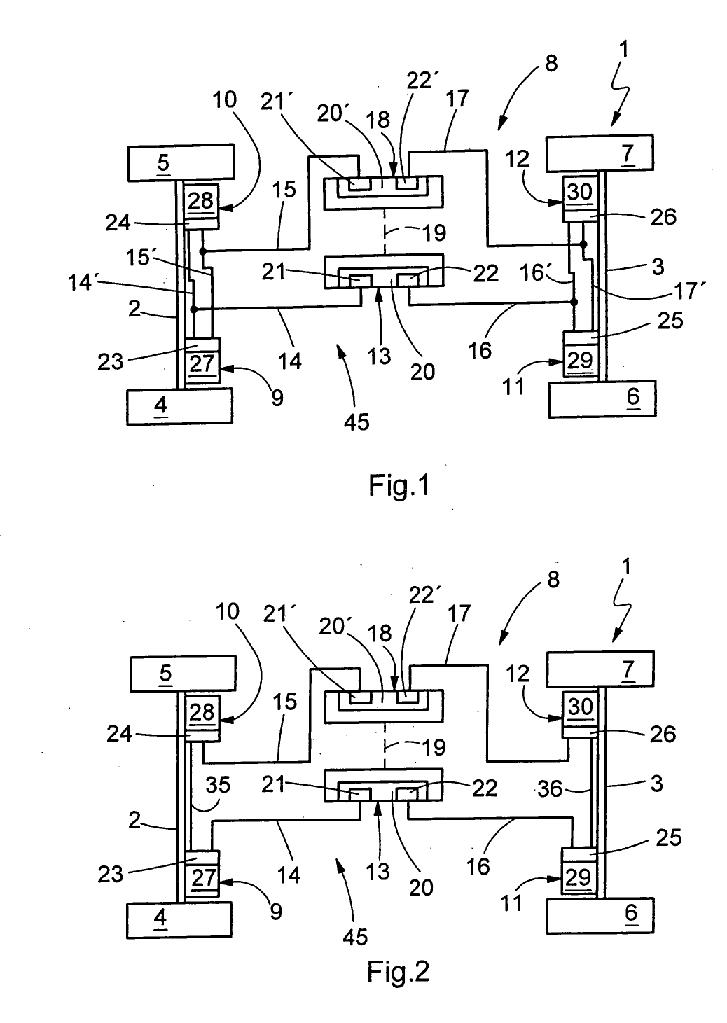

According to FIG. 1, a vehicle 1 illustrated only in part comprises at least one front axle 2 and at least one rear axle 3. With regard to the direction of travel, the front axle 2 has at least one left-hand front wheel 4 and at least one right-hand front wheel 5. Likewise, with regard to the direction of travel, the rear axle 3 also has at least one left-hand rear wheel 6 and at least one right-hand rear wheel 7. It is clear that, in another embodiment, the vehicle 1 may also comprise a plurality of rear axles 3 and in particular also a plurality of front axles 2. Moreover, in the case of a rear axle 3, the individual rear wheels 6, 7 may for example take the form of dual wheels or twin wheels.

Furthermore, the vehicle 1 is provided with a service brake 8, by way of which the vehicle 1 may be braked, i.e., the service brake 8 serves to brake the individual wheels 4 to 7 of the vehicle 1. For each brakable wheel 4 to 7, the service brake 8 comprises a separate brake unit, namely a front left-hand brake unit 9, a front right-hand brake unit 10, a rear left-hand brake unit 11 and a rear right-hand brake unit 12. The brake units 9 to 12 are in each case configured to be electronically actuatable. For example, the brake units 9 to 12 are electromechanical brake units, which convert electrical energy into mechanical braking work. Again for example, such an electromechanical brake has an electric motor as an actuator that, when actuated, presses conventional brake shoes against a conventional brake disc.

The service brake 8 forms an essential component of a brake control system 45, which is additionally equipped with a first central control device 13, which is connected to the brake units 9 to 12 via at least one control line. Linkage or coupling to the brake units 9 to 12 is effected so that the first central control device 13 may actuate the individual brake units 9 to 12 independently of one another. In the embodiment according to FIG. 1, four such control lines 14, 15, 16, 17 are provided.

Moreover, the brake control system 45 comprises a second central control device 18 that is connected redundantly to the first central control device 13. In this way, the operating and functional safety of the service brake 8 or of the brake control system 45 may be improved, because, in the event of failure of the first central control device 13, the second central control device 18 may provide an adequate replacement for the first central control device 13. The vehicle 1 is thus provided with a redundant brake control system 45.

In the embodiments illustrated herein, the service brake 8 takes the form of a wired system, i.e., it has no compulsory mechanical or hydraulic coupling between a braking force setpoint generator, such as for example a brake pedal, and the individual brake units 9 to 12. Preferably, the system is here accordingly what is termed a “brake-by-wire system”, in which a braking command is forwarded electrically to the individual brake units 9 to 12 and implemented there. Accordingly, the control lines 14 to 17 comprise electrical leads for transmitting electrical signals that serve to actuate the individual brake units 9 to 12.

The electronic coupling between an input level of the brake control system 45, in the form of a braking force setpoint generator such as, for example a brake pedal, and an output level of the brake control system 45, in the form of brake units 9 to 12 cooperating with the wheels 4 to 7, is preferably hierarchically structured in the present invention. To this end, a brake modulator 20 is provided to determine an axle brake command for each axle 2, 3 as a function of preset values relating to vehicle movement dynamics.

The preset values for vehicle movement dynamics taken into account here may consist not only of a setpoint for vehicle deceleration desired by the vehicle driver but also of current state variables of a stabilization system, such as for example steering angle and/or transverse acceleration that may have an effect on the respective braking operation.

An axle modulator 21 or 22 respectively for each axle 2, 3 is then connected downstream of the brake modulator 20. Each axle modulator 21, 22 determines a wheel braking command for each assigned wheel 4 to 7 from the associated axle braking command. While the axle braking commands may differ from one another in that the brake modulator 20 assigns different braking moments to the individual axles 2, 3, the wheel braking commands may differ from one another within the respective axle 2, 3 through a different left-right distribution of the desired braking forces.

A separate wheel modulator 23 to 26 for each wheel 4 to 7 is then arranged downstream of the individual axle modulators 21, 22. The wheel modulators 23 to 26 determine, as a function of the associated wheel braking commands, actuating signals for actuating brake actuators 27 to 30 that are associated with the respective brake unit 9 to 12. The brake actuators 27 to 30 then individually execute the respective wheel braking command. The structure allows, inter alia, the individual required wheel modulators 20 to 26 to be arranged non-centrally. In the embodiments of FIGS. 1, 2, 6 and 7, the wheel modulators 23 to 26 are arranged, for example, on the individual brake units 9 to 12 or integrated therein. In contrast thereto, in the embodiments of FIGS. 1 and 2, the axle modulators 21, 22 are integrated into the first control device 13 or into the brake modulator 20. Likewise, the brake modulator 20 is integrated into the first control device 13 in all embodiments.

The brake control system 45 is conveniently equipped with a dynamic system for vehicle stabilization. Such a stabilization system is, for example, an anti-lock braking system (ABS), anti-slip regulation (ASR) or a so-called ESP system. Likewise, an electronic all-wheel system may contribute to vehicle stabilization.

The hierarchical structure of the brake control system 45 allows wheel-specific components of such a stabilization system to be arranged or provided in the axle modulators 21, 22. Likewise, axle-specific and/or vehicle-specific components of these stabilization systems may then be arranged or provided in the brake modulator 20. Moreover, the wheel modulators 23 to 26 may comprise local control loops that act in the plane of the respective wheel 4 to 7.

In principle, the second control device 18 may be identical in structure to the first control device 13, so as to be able to replace the latter completely in an emergency. Operation of the vehicle 1 is then not restricted in any way in the event of failure of the first control device 13. Accordingly, the second control device 18 also comprises a brake modulator 20′ and two axle modulators 21′ and 22′ respectively. In contrast thereto, reduced functionality to the second control device 18 can be assigned compared to the first control device 13, whereby the second control device 18, which is not needed as a rule, may be produced more cheaply.

In the embodiments of FIGS. 1 to 7, the operating safety of the redundant brake control system 45 is increased according to the present invention in that, of the two front control lines 14, 15 provided for actuation of those brake units 9, 10 that are associated with the front axle 2, at least one or the first, here the left-hand control line 14, is connected to the first central control device 13. In contrast thereto, of the two rear control lines 16, 17 which serve to actuate those brake units 11, 12 which are associated with the rear axle 3, at least one or the first, here the right-hand control line 17, is connected to the second central control device 18.

Furthermore, in the embodiments of FIGS. 1 to 3, the other one or second of the front control lines 14, 15, i.e. here the right-hand control line 15, is connected to the second control device 18, while the other one or second of the two rear control lines 16, 17, i.e. here the left-hand control line 16, is connected to the first control device 13. In this way, the brake units 9, 10 of the front axle 2 and the brake units 11, 12 of the rear axle 3 are automatically connected to both control devices 13, 18 via separate control lines 14 to 17.

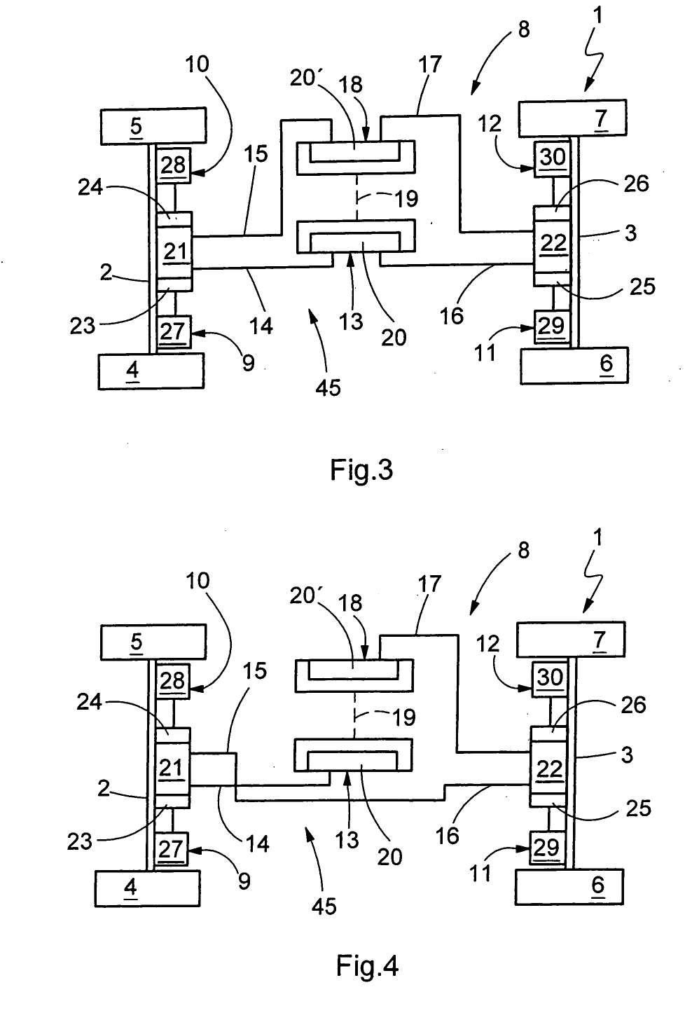

A redundant connection is then provided in the area of the individual axles 2, 3. To this end, in the embodiment according to FIG. 3 the two front control lines 14, 15 are each connected to both wheel modulators 23, 24, for which purpose a corresponding auxiliary line 14′ or 15′ respectively branches off from the respective control line 14, 15. The same takes place with regard to the rear axle 3, such that the left-hand rear control line 16 is connected to the rear left-hand wheel modulator 25 and via an auxiliary control line 16′ to the rear right-hand wheel modulator 26. Likewise, the rear right-hand control line 17 is connected directly to the rear right-hand wheel modulator 26 and indirectly via an auxiliary control line 17′ to the rear left-hand wheel modulator 25. The respective control device 13, 18 ultimately emits coded wheel braking commands for all the vehicle wheels 4 to 7, such that, in the event of failure of one of the control devices 13, 18, the wheel braking commands produced by the remaining control device 13 or 18 respectively always reach the respective wheel modulator 23 to 26 as a result of the networking provided.

In the embodiment according to FIG. 2, the redundant connection in the area of the axles 2, 3 is achieved in that, on one hand, at each axle 2, 3 the two control lines 14, 15 or 16, 17 respectively connect the one wheel modulator 23 or 25 to the first control device 13 and the other wheel modulator 24 or 26 to the second control device 18. On the other hand, a coupling line 35 or 36 is provided at each axle 2, 3, which line connects together the two wheel modulators 23 and 24 or respectively 25 and 26 of the respective axle 2, 3. These coupling lines 35, 36 are configured or connected such that they transmit the signals, supplied via the one control line 14 or 15 or respectively 16 or 17 to the one wheel modulator 23 or 24 or 25 or 26, respectively, to the respective other wheel modulator 24 or 23 or 26 or 25 on the same axle 2, 3.

Thus, networking is achieved here too, so that, in the event of failure of one of the control devices 13, 18, the brake units 9 to 12 can be reached with the remaining control device 13, 18 via the networking in the area of the axles 2, 3. By way of such networking in the area of the axles 2, 3, it is in principle also possible to connect the first, for example the left-hand front control line 14 to the first control device 13 and the first or right-hand rear control line 17 to the second control device 18 and moreover to connect the second or right-hand front control line 15 to the second or left-hand rear control line 16. In this way, networking is also provided here, so that, in the event of failure of one of the two control devices 13, 18, all the wheel modulators 23 to 26 individually can be reached with the control commands of the remaining control device 13, 18.

In the embodiments of FIGS. 3 to 7, the axle modulators 21 and 22 are each arranged on or near to the associated axle 2 or 3, respectively. In these embodiments, the axle modulators 21, 22 are thus arranged non-centrally relative to the control devices 13, 18. In this way, a complete mechatronic axle module may be produced that, for example, makes possible local ABS control of the respective axle 2, 3.

In the embodiments of FIGS. 3 to 5, the wheel modulators 23 to 26 that are associated with the wheels 4 to 7 of the same axle 2 or 3 respectively, are each integrated into the axle modulator 21 or 22 respectively associated with said axle 2, 3. In this way, jointly usable components such as, for example, power supply units, may be used for both wheel modulators 23 to 26 on the same axle 2, 3. Integration of the wheel modulators 23 to 26 into the axle modulators 21, 22 therefore brings about a saving in hardware components.

In addition to arranging or integrating the wheel modulators 23 to 26 on or in the brake units 9 to 12 or in the axle modulators 21, 22, it is in principle also contemplated to accommodate the wheel modulators 23, 26 in the respective central control device 13 or 18, respectively, or to integrate them therein.

In the embodiments of FIGS. 3 to 7, both front control lines 14, 15 are connected to the front axle modulator 21 that is associated with the front axle 2. Likewise, both rear control lines 16, 17 are also connected to the rear axle modulator 22 that is associated with the rear axle 3. The embodiments of FIGS. 3 to 5 differ through different networking of the axle modulators 21, 22 with the two control devices 13, 18.

In the embodiment according to FIG. 3, the first or left-hand front control line 14 is connected to the first control device 13, while the second or right-hand front control line 15 is connected to the second control device 18. Likewise, the first or right-hand rear control line 17 is connected to the second control device 18, while the second or left-hand rear control line 16 is connected to the first control device 13. In other words, both control devices 13, 18 directly actuate both axle modulators 21, 22.

In the embodiment according to FIG. 4, the first, left-hand front control line 14 is again connected to the first control device 13, while the first, right-hand rear control line 17 is again connected to the second control device 18. In contrast, the second control lines, i.e. the right-hand front control line 15 and the left-hand rear control line 16, are connected directly together. The two axle modulators 21, 22 are configured such that they transmit signals, supplied by the respective control device 13, 18 via the in each case first control line 14, 17, via the second control lines 15, 16 to the in each case other axle modulator 21, 22. In this way networking is likewise provided, but with less complex wiring, and allows actuation of all the wheel modulators 23 to 26 or all the brake units 9 to 12 on failure of one of the two control devices 13, 18.

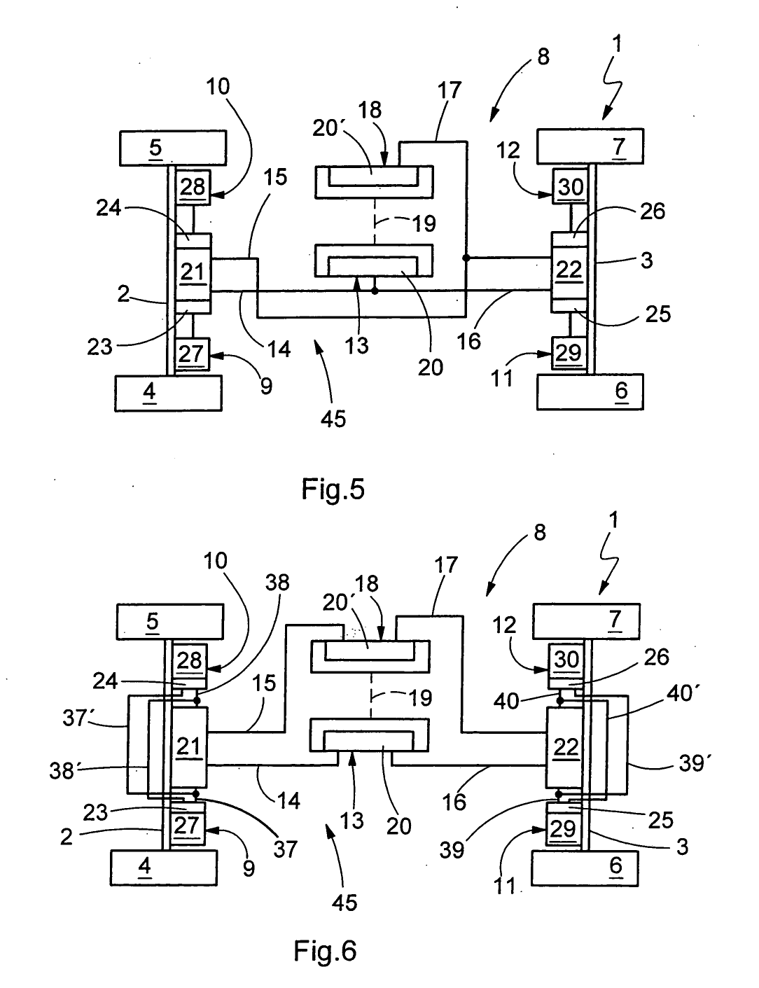

FIG. 5 shows a further alternative development with regard to networking of the axle modulators 21, 22 with the control devices 13, 18. In this embodiment, the first or left-hand front control line 14 is connected to the first control device 13, while the first or right-hand rear control line 17 is connected to the second control device. Furthermore, the first front control line 14 is additionally connected to the second, left-hand rear control line 16. Likewise, the first rear control line 17 is connected to the second, right-hand front control line 15. Networking is also achieved in this way to allow actuation of all the brake units 9 to 12 with the remaining control device 13, 18 should one of the control devices 13, 18 fail.

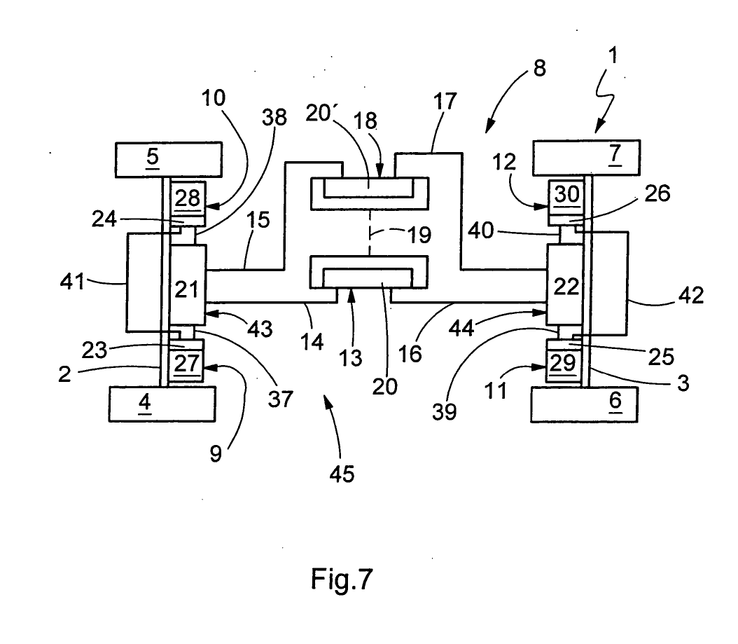

FIGS. 6 and 7 show examples of additional networking in the area of the respective axles 2, 3, for instance in which the individual wheel modulators 23 to 26 are not integrated into the axle modulators 21, 22 but rather are arranged on or in the brake units 9 to 12. In these embodiments, the axle modulators 21, 22 are each connected via two axle control lines 37 to 40 to the two wheel modulators 23 to 26 of the associated axle 2, 3. In order to provide additional networking of the wheel modulators 23 to 26 in the area of the respective axle 2, 3, in the embodiment according to FIG. 6 the two axle control lines 37, 38 or 39, 40 are respectively connected to the two wheel modulators 23, 24 or respectively 25, 26 of the associated axle 2, 3, this being achieved via corresponding auxiliary or branch lines 37′ to 40′.

Alternatively, networking of the wheel modulators 23 to 26 corresponding to the embodiment shown in FIG. 7 may also be achieved in that, on one hand the axle control lines 37 to 40 of the axle modulators 21, 22 are each connected to only one of the wheel modulators 23 to 26. In addition, on the other hand, the two wheel modulators 23, 24 or respectively 25, 26 of the respective axle 2, 3 are connected together via a coupling line 41 or 42, respectively. The individual wheel modulators 23 to 26 are then configured such that they transmit signals, supplied to them via the associated actuating line 37 to 40, via the respective coupling line 41, 42 to the respective other wheel modulator 23 to 26 of the same axle 2, 3.

In the embodiments of FIGS. 3 to 7, the axle modulators 21, 22 are each accommodated in an axle control device 43 or 44, respectively, which is arranged in each case on or near to the respective axle 2 or 3, respectively. In the embodiments of FIGS. 3 to 5, the wheel modulators 23 to 26 are integrated into the axle control device 43 or 44 assigned to the associated axle 2, 3.

In order to be able to implement the networking described herein, the individual control lines 14 to 17 or the individual axle control lines 37 to 40 or the individual coupling lines 35, 36 or 41, 42 respectively preferably each take the form of buses, such that the individual control commands may be sent as coded signals over the network produced in this way.

The embodiments shown in FIGS. 1 to 7 for networking the brake units 9 to 12 with the control devices 13, 18 may—where appropriate—be combined in any desired way, in particular the networking at the level of the axles 2, 3 according to FIGS. 6 and 7 may also be combined with the networking at the level of the control devices 13, 18 according to FIGS. 1 to 5.

The first control device 13 and, where present, also the second control device 18 preferably comprises wheel-specific components of a steer-by-wire system and may additionally be constructed such that it actuates the individual brake units 9 to 12 during a braking operation as a function of a braking algorithm that is constructed to allow intervention in the steering of the vehicle if certain parameters are present. Such intervention in steering is intended, for example, in the case of a dynamic vehicle stabilization system, which is known in specialist circles as ESP III. In this configuration, parts of such a stabilization system are thus already linked within the control device 13, 18 to suitable components of the steer-by-wire system to improve the performance of the stabilization system and reduce the system price.

Another particularly advantageous configuration is one in which the first control device 13, and in particular also the second control device 18, executes a coordination algorithm during a braking operation. This operation distributes a braking force necessary for braking the vehicle as a function of this coordination algorithm to the service brake 8 and, where present, to an engine brake of the vehicle 1 and, where present, to a retarder of the vehicle 1. Provision may also be made to enhance the engine brake by actuating an actuatable transmission in the change-down direction. Optimum distribution of the braking force to the various braking systems of the vehicle 1 reduces the wear and energy consumption of the vehicle 1. For example, minor braking operations may be performed solely with the retarder or solely with the engine brake, which both operate in wear-free manner compared with the service brake 8.

The first control device 13, and preferably also the second control device 18, operates normally with a main braking algorithm to ensure, during a braking process, that the braking force to be achieved by the service brake 8 is distributed to the individual brake units 9 to 12 as a function of this main braking algorithm. In addition to the main braking algorithm, the first control device 13, and in particular also the second control device 18, may be equipped with at least one emergency braking algorithm that replaces the main braking algorithm in emergency operation.

Different emergency braking algorithms may be provided for different instances of emergency operation. Such emergency operation is characterized by the failure of at least one brake unit 9 to 12. A suitable emergency braking algorithm may then be determined or selected for the particular instance of emergency operation, which then actuates the remaining functional brake units 9 to 12 to brake the vehicle 1 as a function of the respective emergency braking algorithm. This emergency braking algorithm takes account of the respectively failed brake unit 9 to 12 when distributing the braking force to the remaining functional brake units 9 to 12.

As described above, it is now possible, within certain limits, to achieve comparatively safe braking of the vehicle 1 even in the event of failure of one or more brake units 9 to 12. An essential feature in implementing such a safety concept is the provision of a four-circuit system in the case of four brake units 9 to 12. This has been achieved in the preset invention by separate actuation of the individual brake units 9 to 12.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-10. (canceled)

11. A brake control system for a vehicle having at least one front axle with at least one left-hand front wheel and at least one right-hand front wheel; at least one rear axle with at least one left-hand rear wheel and at least one right-hand rear wheel; a service brake for braking the wheels of the vehicle, wherein the service brake (8) is provided with:
(a) at least one electronically actuatable front left-hand brake unit for actuating braking of the at least one left-hand front wheel, (b) at least one electronically actuatable front right-hand brake unit for actuating braking of the at least one right-hand front wheel, (c) at least one electronically actuatable rear left-hand brake unit for actuating braking of the at least one left-hand rear wheel, and (d) at least one electronically actuatable rear right-hand brake unit for actuating braking of the at least one right-hand rear wheel;
a first central control device operatively connected via at least one control line to the brake units so as to allow actuation of the brake units independently of one another;
a second central control device operatively connected to at least one of the first control device and the at least one control line, and operatively connected redundantly to the first control device;
two front control lines arranged to actuate the brake units associated with the front axle, of which at least the first control line is connected to the first control device;
two rear control lines arranged to actuate the brake units associated with the rear axle, of which at least the first control line is operatively connected to the second control device;
a brake modulator arranged to determine an axle braking command for each axle from preset values relating to vehicle movement dynamics;
an axle modulator for at least one axle configured to determine a wheel braking command for each wheel from the associated axle braking command;
a wheel modulator for each wheel configured to determine an actuating signal from the associated wheel braking command for a brake actuator of the associated brake unit, the axle modulators are arranged on or near to the respectively associated axle, wherein: the two front control lines are operatively connected to the front axle modulator associated with the front axle and the two rear control lines are operatively connected to the rear axle modulator associated with the rear axle, at least in the case of one of the axles, the associated axle modulator is operatively connected via two actuating lines to both the wheel modulators of both the brake units of the one axle, the two axle control lines are each operatively connected to only one of the wheel modulators, the one wheel modulator is operatively connected to the other wheel modulator and is operable to transmit the signals, supplied to the one wheel modulator via the one axle control line, to the other wheel modulator.

12. The brake control system as claimed in claim 11, wherein at least one dynamic system is provided for vehicle stabilization and has wheel-specific components arranged in the axle modulators as well as at least one of axle-specific and vehicle-specific components arranged in the brake modulator.

13. The brake control system as claimed in claim 11, wherein one of the following is provided: (a) the wheel modulators are integrated into the associated brake unit, (b) the wheel modulators associated with the wheels of the same axle are each integrated into the axle modulator associated with this axle, and (c) the wheel modulators are integrated into the brake modulator.

14. The brake control system as claimed in claim 11, wherein at least one dynamic system is provided for vehicle stabilization and has wheel-specific components arranged in the axle modulators as well as at least one of axle-specific and vehicle-specific components arranged in the brake modulator.

15. The brake control system as claimed in claim 11, wherein at least one of the brake modulator is integrated into the first central control device, and the axle modulators are each arranged on or near to the associated axle.

16. The brake control system as claimed in claim 15, wherein one of the following is provided: (a) the wheel modulators are integrated into the associated brake unit, (b) the wheel modulators associated with the wheels of the same axle are each integrated into the axle modulator associated with this axle, and (c) the wheel modulators are integrated into the brake modulator.

17. The brake control system as claimed in claim 11, wherein, for at least one axle, the first control line is operatively connected to the wheel modulator of the one brake unit and the second control line is connected to the wheel modulator of the other brake unit, and for the at least one axle, the one wheel modulator is connected via a coupling line to the other wheel modulator and transmits the signals, supplied to the one wheel modulator via the one control line, to the other wheel modulator.

18. The brake control system as claimed in claim 11, wherein for at least one axle, the control lines are operatively connected to the respective wheel modulators of the respective brake units.

19. The brake control system as claimed in claim 18, wherein the second front control line is operatively connected to the second rear control line and transmits the signals, supplied to the one axle modulator via the respective first control line, to the other axle modulator.

20. The brake control system as claimed in claim 11, wherein the second front control line is operatively connected to the second control device one of indirectly via the first rear control line and directly, and in that the second rear control line is operatively connected to the first control device one of indirectly via the first front control line and directly.

21. The brake control system as claimed in claim 11, wherein the front control lines operatively connect the front axle modulator redundantly to at least one of the first control device and the second control device, and the rear control lines operatively connect the rear axle modulator redundantly to at least one of the first control device and the second control device.

22. The brake control system as claimed in claim 11, wherein at least for one of the axles, the associated axle modulator is operatively connected via two axle control lines to the wheel modulators of the respective brake units of the one axle, and the axle control lines are operatively connected to the respective wheel modulators of the one axle.
